(19) United States
(12) Patent Application Publication
(10) Pub. No.: US 2007/0283758 A1
(43) Pub. Date: Dec. 13, 2007

(54) Sensor

(75) Inventors: Hiroyuki Funo, Ashigarakami-gun (JP); Masao Watanabe, Ashigarakami-gun (JP); Kiyoshi Iida, Ashigarakami-gun (JP); Ryota Mizutani, Ashigarakami-gun (JP); Yasuaki Konishi, Ashigarakami-gun (JP)

Correspondence Address: OLIFF & BERRIDGE, PLC, P.O. BOX 19928, ALEXANDRIA, VA, 22320, US

(73) Assignee: FUJI XEROX CO., LTD., TOKYO (JP)

(21) Appl. No.: 11/546,463

(22) Filed: Oct. 12, 2006

(30) Foreign Application Priority Data
Jun. 13, 2006 (JP) 2006-163949

(51) Int. Cl. G01H 17/00

(52) U.S. Cl. 73/570; 73/649

(57) ABSTRACT

A sensor includes: a receiver that receives signals sent from outside; a first converter that converts signals received by the receiver into acoustic waves; a second converter that converts the acoustic waves propagating along a predetermined area into signals; a transmitter that transmits the signals that are output from the second converter; and an attachment that is attached to a propagation path of the acoustic waves on the predetermined area, that undergoes an irreversible change in response to an environmental change and that changes the propagation characteristics of the acoustic waves on the predetermined area due to this change.

### BACKGROUND

1. Technical Field

The present invention relates to sensors.

2. Related Art

Sensors are known that acquire, from a distance, the temperature history of an environment in which goods are placed while those goods are being transported or stored. Such sensors are used to ascertain whether, for example, frozen food or the like has been kept in its frozen state until its arrival at a retail store or the consumer.

As this type of sensor, IC tags incorporating a temperature sensor as well as IC tags whose resonance frequency changes in accordance with a temperature change are known. Such sensors are queried at constant time intervals with a querying device, and data representing temperature is acquired. However, with this system, the data representing the temperature history is stored as electronic data, so that there is the risk that the data representing the temperature history is tampered with.

### SUMMARY

In order to address the above-noted issues, a sensor in accordance with an embodiment of the present invention includes a receiver that receives signals sent from outside; a first converter that converts signals received by the receiver into acoustic waves; a second converter that converts the acoustic waves propagating along a predetermined area into signals; a transmitter that transmits the signals that are output from the second converter; and an attachment that is attached to a propagation path of the acoustic waves on the predetermined area, that undergoes an irreversible change in response to an environmental change and that changes the propagation characteristics of the acoustic waves on the predetermined area due to this change.

### BRIEF DESCRIPTION OF THE DRAWINGS

Exemplary embodiment(s) of the present invention will be described in detail based on the following figures, wherein:

FIGS. 1A and 1B shows a configuration of a sensor 101;

FIG. 2 shows a configuration of a querying device 200;

FIG. 3 is a flowchart illustrating the operations of the sensor 101 and the querying device 200;

FIG. 4 shows an example of the table 203;

FIG. 5 shows a sensor 102;

FIG. 6 shows a sensor 103;

FIGS. 7A to 7D show a sensor 104;

FIGS. 8A to 8D show a sensor 105;

FIG. 9 shows a sensor 106; and

FIG. 10 shows a sensor 107.

### DETAILED DESCRIPTION

The following is an explanation of exemplary embodiments of the present invention, with reference to the accompanying drawings.

### Configuration

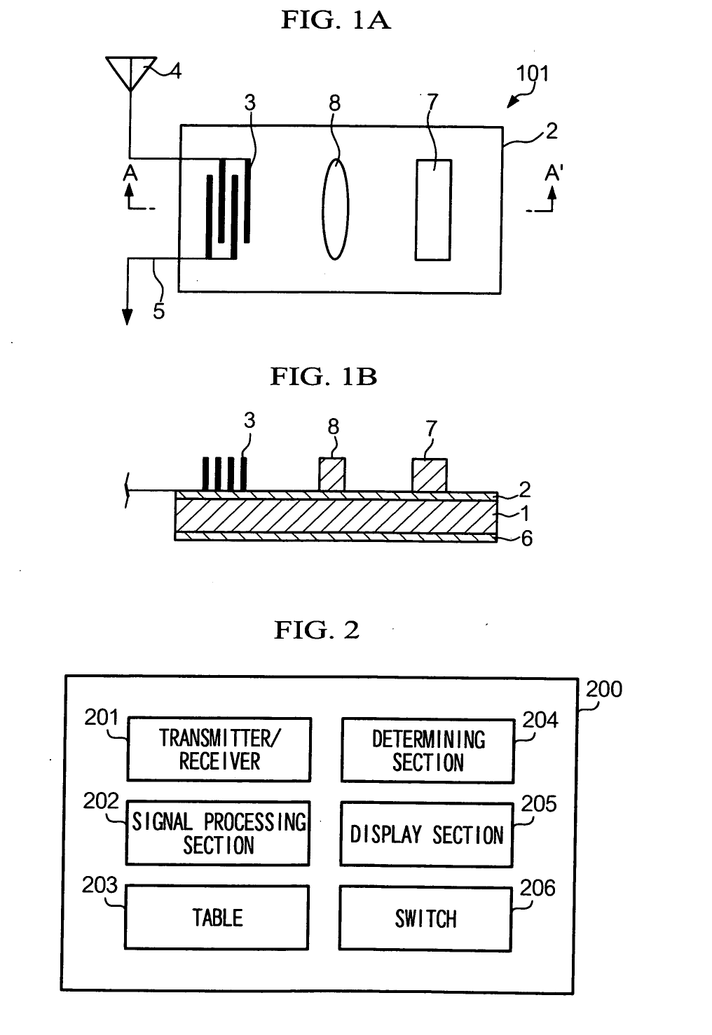

FIG. 1 shows a configuration of a sensor 101. FIG. 1A is a plan view of the sensor 101 and FIG. 1B is a cross-sectional view of the sensor 101, taken along the line A-A′.

A ferroelectric thin film 2 is formed on the surface of a substrate 1. An IDT (inter-digital transducer) 3, an antenna 4, a ground 5, a reflector 7, and a lump of wax (attachment) 8 are formed on the ferroelectric thin film 2. The IDT 3 includes two sets of comb-shaped electrodes that face each other. The antenna 4 is connected to one of those two sets of comb-shaped electrodes, and the ground 5 is connected to the other of those two sets of comb-shaped electrodes. A ground electrode 6 is formed on the rear side of the substrate 1, and the ground 5 is connected to this ground electrode 6 by a through hole (not shown in the drawings).

The ferroelectric thin film 2 is formed using LiTaO₃, for example. From the viewpoint of the electromechanic coupling coefficient/piezoelectric coefficient of the IDT 3 and dielectric losses of the antenna 4, it is preferable that this ferroelectric thin film 2 is an epitaxial layer or has a single orientation. Moreover, it is also possible to form a III-V semiconductor such as GaAs, or carbon such as diamond, on the ferroelectric thin film 2. Thus, it is possible to increase, for example, the surface speed of surface acoustic waves, the coupling coefficient and the piezoelectric constant.

It should be noted that instead of the substrate 1 and the ferroelectric thin film 2, it is also possible to use a plate-shaped member that includes (or made of) a ferroelectric material as the substrate.

The IDT 3, the antenna 4 and the ground 5 are formed in an integrated manner by a conductive pattern. As the material for this conductive pattern, it is preferable to layer a single layer or a multi-layered structure of two or more layers of a metal such as Ti, Cr, Cu, W, Ni, Ta, Ga, In, Al, Pb, Pt, Au, Ag or the like or an alloy such as Ti—Al, Al—Cu, Ti—Ni, Ni—Cr or the like. It is particularly preferable to use Au, Ti, W, Al or Cu as the metal. Moreover, it is preferable that the thickness of the metal layer is at least 1 nm (nanometer) and less than 10 μm (micrometer).

The lump of wax 8 is formed in a predetermined shape in a region between the IDT 3 and the reflector 7 on the ferroelectric thin film 2 (that is, in a propagation path for surface acoustic waves). In this exemplary embodiment, it is provided with an elliptical shape when viewed from above and with a rectangular shape in the cross-section along A-A′, as shown in FIG. 1. The lump of wax 8 melts when the melting point of the wax is reached. The melted lump of wax spreads thinly on the ferroelectric thin film 2 and takes up a larger area on the ferroelectric thin film 2 than before it has melted. And when the temperature drops below the melting point, the lump of wax 8 solidifies in a state where it has spread thinly due to the melting. In other words, its shapes before and after the melting are different. When the molten lump of wax 8 is left alone, it will not return to its original shape. That is to say, the lump of wax 8 undergoes an irreversible change regarding its shape. Thus, in the present application, “irreversible change” does not mean that the change of the state is under no circumstances irreversible, but rather that a change that has occurred due to an environmental change will not return to the original state or shape regardless of a shift in this environmental change, and will not return to the original state or shape unless an external force other than that due to the environmental change is applied.

FIG. 2 shows a configuration of a querying device 200.

A transmitter/receiver 201 has an antenna and transmits/receives radio signals to/from the sensor 101.

A signal processing section 202 generates signal having a predetermined amplitude and frequency and feeds this signal to the transmitter/receiver 201. The signal processing section 202 also subjects a received signal to a predetermined process to determine a physical quantity or a parameter (amplitude, phase velocity or the like) of the signal.

A table 203 includes information showing the correspondence between the physical quantity of the signal and the environment in which the sensor has been put.

A determining section 204 determines whether the temperature around the sensor 101 has reached the melting point of the wax, by comparing the physical quantity of the received signal with the content of the table 203. The content of the table 203 and processing that is carried out by the determining section 204 is explained in more detail later.

A display section 205 displays an image representing the result of the judgment performed by the determining section 204.

When a switch 206, which is for example a switch of the push button type, is pushed down, the transmitter/receiver 201 transmits radio signals to the sensor 101.

The following is an explanation of the operation of the sensor 101 and the querying device 200.

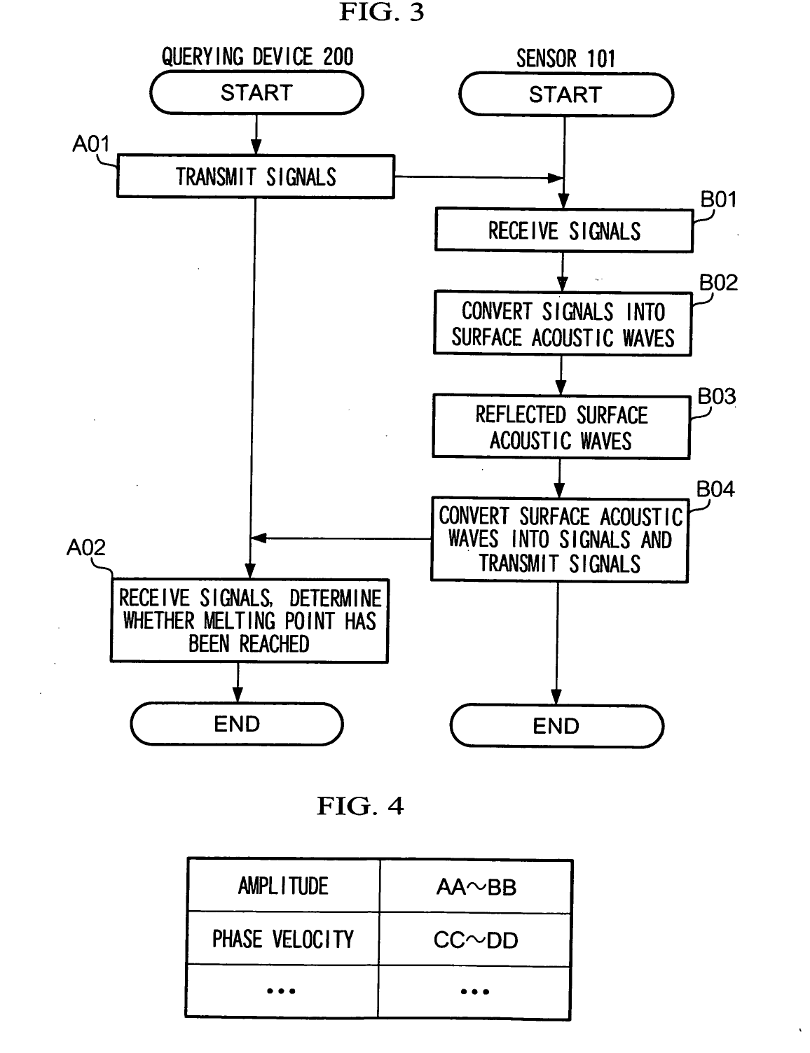

FIG. 3 is a flowchart illustrating the operations of the sensor 101 and the querying device 200.

First, when the switch 206 is pushed down in Step A01, the transmitter/receiver 201 transmits a radio signal having a predetermined frequency and amplitude to the sensor 101.

In Step B01, the antenna 4 of the sensor 101 receives this radio signal. Having received the radio signal, the antenna 4 converts this radio signal into an electric signal and feeds this electric signal to the IDT 3.

In Step B02, the IDT 3 generates a surface acoustic wave at the surface of the ferroelectric thin film 2, in accordance with this electric signal. This surface acoustic wave propagates along the ferroelectric thin film 2 and reaches the reflector 7.

In Step B03, the reflector 7 reflects the surface acoustic wave that has reached it. The reflected surface acoustic wave is propagated along the ferroelectric thin film 2 and reaches the IDT 3.

In Step B04, the IDT 3 converts the surface acoustic wave into an electric signal and feeds it to the antenna 4. The antenna 4 converts this electric signal into a radio signal and transmits this radio signal.

In Step A02, the querying device 200 receives the radio signal sent by the sensor 101. The querying device 200 determines the physical quantity (amplitude, phase velocity or the like) of the received signal. Then, by looking up the table 203, the determining section 204 determines whether the temperature around the sensor 101 has reached the melting point.

FIG. 4 is a diagram illustrating the content of the table 203. The table 203 stores the region of the physical quantity (amplitude, phase velocity or the like) of the signal sent from the sensor 101 in the event that the temperature around the sensor 101 has reached the melting point of the wax, that is, in the event that the lump of wax 8 has melted.

The following is an explanation of the propagation of the surface acoustic waves. As the surface acoustic waves generated by the IDT 3 propagate along the ferroelectric thin film 2, their propagation characteristics depend on the material, shape, temperature and the like of the ferroelectric thin film 2, the substrate 1 and the lump of wax 8. In the event that the temperature around the sensor 101 reaches the melting point of the wax, the wax spreads thinly over the ferroelectric thin film 2. And in the event that the temperature drops below the melting point after this, the wax solidifies but its shape does not return to its original shape. Thus, the propagation characteristics of the surface acoustic waves on the ferroelectric thin film 2 change, and as a result, the physical quantity (amplitude, phase velocity or the like) of the surface acoustic waves change. Consequently, by experimentally determining beforehand the physical quantity of the output signal for the case that the temperature around the sensor 101 has reached the melting point of the wax, storing it in the table 203 and comparing the stored content with the physical quantity of the actual output signal, it is possible to determine whether the temperature around the sensor 101 has reached the melting point of the wax.

In this manner, the determining section 204 determines whether the temperature around the sensor 101 has reached the melting point of the wax.

In the event that it is determined that the temperature around the sensor 101 has reached the melting point of the wax, for example the message “melting point has been reached” is displayed on the display section 205.

It should be noted that the table 203 may also store a range of a physical quantity of the output signal for the event that the temperature around the sensor 101 has not reached the melting point of the wax, that is, the event that lump of wax 8 has not melted. In this case, it is also possible to determine whether the temperature around the sensor 101 has reached the melting point of the wax by letting the determining section 204 compare the stored content with the physical quantity of the actual output signal.

### MODIFIED EXAMPLES

There is no limitation to the above-described exemplary embodiment, and the invention can be embodied in various forms. For example, exemplary embodiments in which the above-described exemplary embodiment is modified as explained below are also possible.

### Modified Example 1

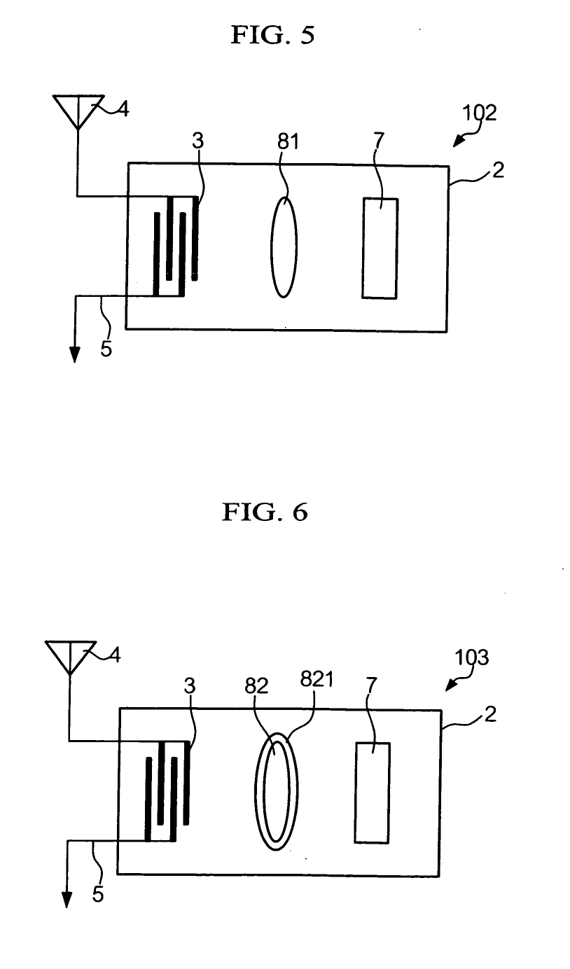

FIG. 5 shows a sensor 102. In this example, a lump of salt 81, that is, a substance having deliquescence is used as the attachment instead of the lump of wax 8 in the above-described exemplary embodiment. The lump of salt 81, can be for example calcium chloride. The lump of salt 81 is covered by a moisture-permeable film, through which for example water molecules in the air can pass through, and is attached to the ferroelectric thin film 2. Thus, in the event that the humidity around the sensor 102 reaches a predetermined humidity, the lump of salt 81 deliquesces. When the lump of salt 81 deliquesces, it will not return to its original shape. Accordingly, as in the above-described exemplary embodiment, the propagation characteristics of the surface acoustic waves change, and thus the physical quantity of the output signal changes, so that it is possible to determine based on the physical quantity of the output signal whether the humidity around the sensor 102 has reached a predetermined value.

### Modified Example 2

FIG. 6 shows a sensor 103. In this example, a photo-curing resin 82, which is cured in the event that it is exposed to light of a specific wavelength, for example ultraviolet light, is provided as the attachment instead of the lump of wax 8 of the above-described exemplary embodiment. This photo-curing resin 82 is placed for example in a transparent container 821 and this container is attached on the ferroelectric thin film 2. Thus, in the event that the sensor 103 is exposed to light, the photo-curing resin 82 is cured. When the photo-curing resin 82 is cured, its mechanical properties change and do not return to the original mechanical properties. Accordingly, as in the above-described exemplary embodiment, the propagation characteristics of the surface acoustic waves change, and thus the physical quantity of the output signal changes, so that it is possible to determine based on the physical quantity of the output signal whether the sensor 103 has been exposed to light.

### Modified Example 3

It is also possible to modify the above-described exemplary embodiment as follows. For example, a substance that produces an antibody in the event that an antigen, such as a microbe, has intruded can be placed into a container as the attachment and this container can be attached on the ferroelectric thin film 2. If the antigen then intrudes into the container, an antigen-antibody reaction takes place, the mechanical properties of the substance inside the container change, and do not return to the original mechanical properties. Accordingly, as in the above-described exemplary embodiment, the physical quantity of the output signal changes compared to prior to the antigen-antibody reaction, so that it is possible to determine based on the physical quantity of the output signal whether an antigen has intruded into the sensor.

### Modified Example 4

It is also possible to modify the above-described exemplary embodiment as follows. For example, a reducing agent such as metallic sodium can be placed into a container as the attachment and this container can be attached on the ferroelectric thin film 2. If oxygen then intrudes into the container, a redox reaction takes place, the mechanical properties of the substance inside the container change, and do not return to the original mechanical properties. Accordingly, as in the above-described exemplary embodiment, the physical quantity of the output signal changes compared to prior to the redox reaction, so that it is possible to determine based on the physical quantity of the output signal whether an oxygen has intruded into the sensor. It is also possible to use an oxidizing agent instead of a reducing agent. That is to say, the attachment may be a substance that undergoes a chemical reaction with a predetermined substance.

### Modified Example 5

It is also possible to modify the above-described exemplary embodiment as follows.

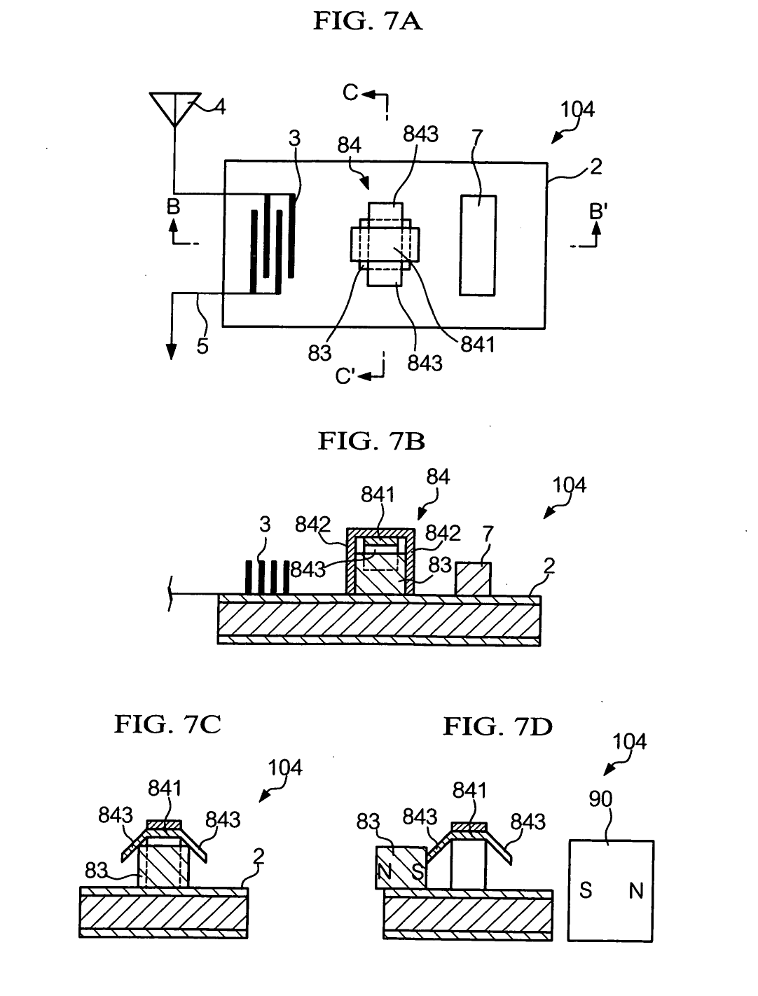

FIG. 7 shows a sensor 104 in which a permanent magnet 83 is attached as the attachment on the ferroelectric thin film 2. FIG. 7A is a top view, FIG. 7B is a cross-sectional view along B-B′ and FIG. 7C is a cross-sectional view along C-C′. As shown in FIG. 7A, a fastener 84 includes a top portion 841 that is rectangular when viewed from above, and two leg portions 842 extend downward from both sides of the top portion 841, as shown in FIG. 7B. The lower ends of the leg portion 842 are fixed on the ferroelectric thin film 2. Moreover, as shown in FIG. 7C, two oblique portions 843 are provided, which face obliquely downward from those of the four sides of the top portion 841 that are not provided with leg portions 842. The two oblique portions 843 are provided such that the distance between their lower ends is larger than the distance between their upper ends, so that they are shaped like this: [symbol] . The fastener 84 is made of metal, plastic or the like, and when an external force acts on the oblique portions 843 and deforms them, an elastic force acts in the direction that restores their shape to their original shape. The permanent magnet 83 is a rectangular solid and is pressed by the two oblique portions 843 against the ferroelectric thin film 2. Moreover, the width of the permanent magnet 83 in FIG. 7B is the same or slightly smaller than the distance between the two leg portions 842. The permanent magnet 83 cannot move in the lateral direction in that figure. With this configuration, when surface acoustic waves are generated on the ferroelectric thin film 2, the permanent magnet 83 oscillates in one piece together with the ferroelectric thin film 2.

In the event that a magnetic force acts on the sensor 104, the following action takes place. In the event that the S-pole of another permanent magnet 90 is brought close to the S-pole of the permanent magnet 83 as shown for example in FIG. 7D, a repulsive force acts between the permanent magnet 83 and the permanent magnet 90. When this repulsive force exceeds a predetermined strength, the permanent magnet 83 pushes up the oblique portion 843 of the fastener 84 and escapes to the left. When the permanent magnet 83 has escaped, the oblique portion 843 is returns to its original shape, so that the permanent magnet 83 will not return to its original position. Thus, the permanent magnet 83 will not form one piece with the ferroelectric thin film 2 anymore, so that the propagation characteristics of surface acoustic waves on the ferroelectric thin film 2 change and the physical quantity of the output signal changes accordingly. Therefore, based on the physical quantity of the output signal, it is possible to determine whether a magnetic force exceeding a predetermined strength has acted on the sensor 104. Moreover, since the movement of the permanent magnet 83 is restrained by two leg portions 842, it can be determined whether a magnetic force exceeding a predetermined strength has acted on the sensor 104 in a predetermined direction (the directions indicated in FIG. 7D).

It should be noted that the shape of the permanent magnet 83 is not limited to that of a rectangular solid, and it may be of any shape. Moreover, it is also possible to provide a permanent magnet, a magnetic body, an adhesive or the like on the ferroelectric thin film 2 in order to hold the permanent magnet 83 that has escaped from the fastener 84.

### Modified Example 6

It is also possible to modify the above-described exemplary embodiment as follows.

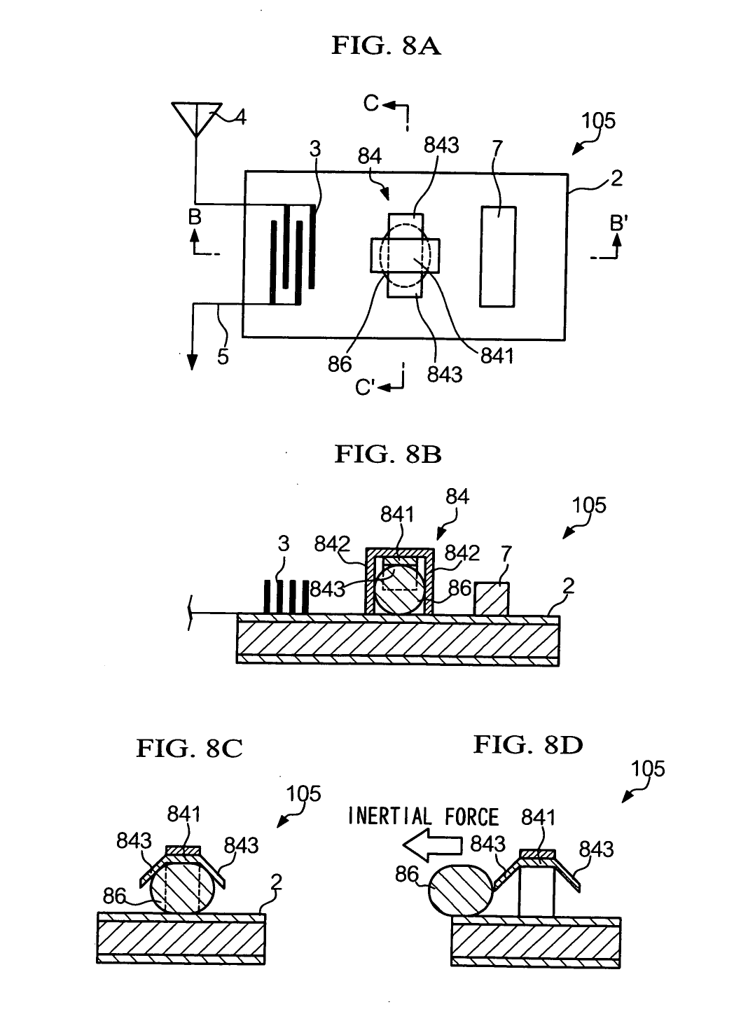

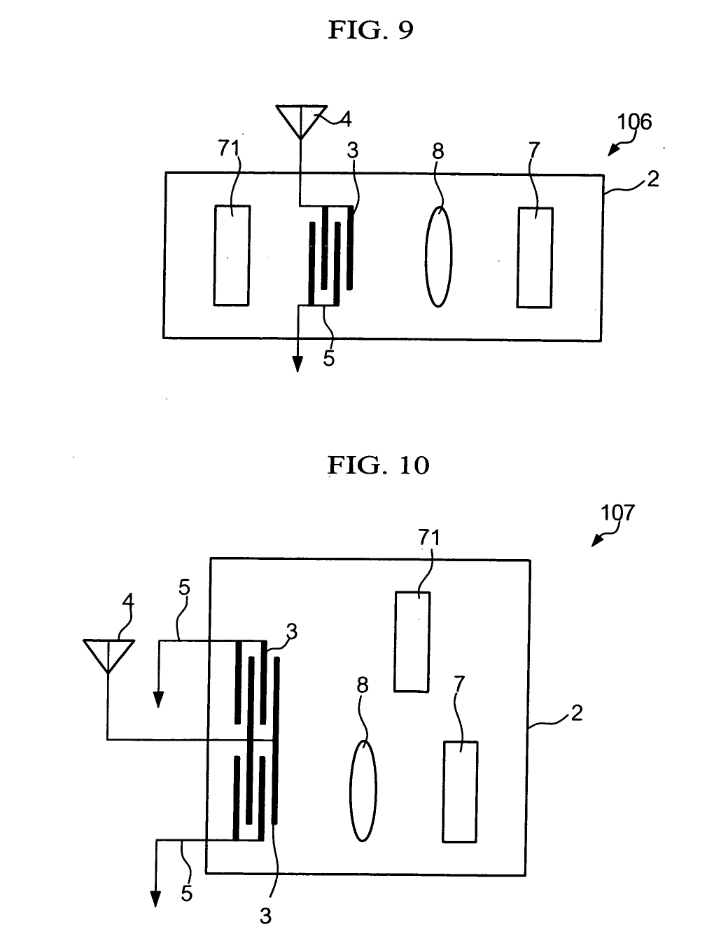

FIG. 8 shows a sensor 105 in which a sphere 86 is attached on the ferroelectric thin film 2 as the attachment. FIG. 8A is a top view, FIG. 8B is a cross-sectional view along B-B′ and FIG. 8C is a cross-sectional view along C-C′. The fastener 84 is the same as that shown in FIG. 7. The sphere 86 is made of metal or the like, and is pushed down against the ferroelectric thin film 2 by the two oblique portions 843. Moreover, the width of the sphere 86 in FIG. 8B is the same or slightly smaller than the distance between the two leg portions 842, and the sphere 86 cannot move in the lateral direction in FIG. 8B. With this configuration, when surface acoustic waves are generated on the ferroelectric thin film 2, the sphere 86 oscillates in one piece together with the ferroelectric thin film 2.

In the event that an inertial force acts on the sensor 105, the following action takes place. In the event that an inertial force exceeding a predetermined strength acts in the direction to the left in FIG. 8D for example, the sphere 86 pushes up the oblique portion 843 of the fastener 84 and escapes to the left. When the sphere 86 has escaped, the oblique portion 843 is returns to its original shape, so that the sphere 86 will not return to its original position. Thus, the sphere 86 will not form one piece with the ferroelectric thin film 2 anymore, so that the propagation characteristics of surface acoustic waves on the ferroelectric thin film 2 change and the physical quantity of the output signal changes accordingly. Therefore, based on the physical quantity of the output signal, it is possible to determine whether an inertial force exceeding a predetermined strength has acted on the sensor 105. Moreover, since the movement of the sphere 86 is restrained by two leg portions 842, it can be determined whether an inertial force exceeding a predetermined strength has acted on the sensor 105 in a predetermined direction (the direction indicated in FIG. 8D).

It should be noted that the attachment in this modified example is not limited to a sphere and it is possible to use any shape. Moreover, it is also possible to provide a permanent magnet (in case that the sphere 86 is magnetic), an adhesive or the like on the ferroelectric thin film 2 in order to hold the sphere 86 that has escaped from the fastener 84.

### Modified Example 7

It is also possible to modify the above-described exemplary embodiment as follows.

FIG. 9 shows a sensor 106. In this example, in addition to the configuration of the above-described exemplary embodiment, one further reflector 71 is provided on the side of the IDT 3 that faces away from the reflector 7. As explained above, when surface acoustic waves generated by the IDT 3 propagate along the ferroelectric thin film 2, a physical quantity (amplitude, phase velocity or the like) of the surface acoustic waves changes depending on the substance, shape and temperature of the ferroelectric thin film 2 and the substrate 1. In this example, the reflector 71 is arranged on the side where there is no lump of wax 8, so that the physical quantity of the surface acoustic waves reflected by the reflector 71 is not influenced by the melting of the wax. Consequently, the physical quantity of the surface acoustic waves reflected by the reflector 71 has a value unique to the sensor 106 that is independent of temperature. This can be utilized to determine the ID for unambiguously identifying the sensor 106 together with the temperature, through the action of the above-described exemplary embodiment.

FIG. 10 shows a sensor 107. This sensor 107 is provided with separate IDTs 3 for each of the reflector 7 and the reflector 71. That is to say, the sensor 107 includes four sets of comb-shaped electrodes. Of those four sets of comb-shaped electrodes, two sets transmit and receive signals corresponding to surface acoustic waves reflected by the reflector 7. The other two sets of the four sets of comb-shaped electrodes transmit and receive signals corresponding to surface acoustic waves reflected by the reflector 71. Also with this configuration, the same operational effect as with the sensor 106 can be attained.

### Modified Example 8

In the above embodiments, the surface acoustic waves that propagates surface of material are described as an example of acoustic waves. The acoustic waves are not restricted to the surface acoustic waves. Acoustic waves that propagates bulk of material may be used as the acoustic wave. In this case, the attachment may be attached to a propagation path of the acoustic waves.

What is claimed is:

1. A sensor, comprising:
a receiver that receives signals sent from outside;
a first converter that converts signals received by the receiver into acoustic waves;
a second converter that converts the acoustic waves propagating along a predetermined area into signals;
a transmitter that transmits the signals that are output from the second converter; and
an attachment that is attached to a propagation path of the acoustic waves on the predetermined area, that undergoes an irreversible change in response to an environmental change and that changes the propagation characteristics of the acoustic waves on the predetermined area due to this change.

2. The sensor according to claim 1, further comprising a substrate, wherein:
the predetermined area is the substrate; and
the acoustic waves are surface acoustic waves.

3. The sensor according to claim 1, wherein the attachment includes a substance that melts when a predetermined temperature is reached.

4. The sensor according to claim 1, wherein the attachment includes a substance that deliquesces when a predetermined humidity is reached.

5. The sensor according to claim 1, wherein the attachment includes a substance that is cured when exposed to light.

6. The sensor according to claim 1, wherein the attachment includes a substance that chemically reacts with a predetermined substance.

7. The sensor according to claim 1, wherein the attachment is provided such that it is removed from the substrate in the event that an external force exceeding a predetermined strength acts on the sensor.

8. The sensor according to claim 1, wherein the attachment is provided such that the position of the attachment changes with respect to the substrate in the event that an external force exceeding a predetermined strength acts on sensor.
